(19) United States
(12) Patent Application Publication
(10) Pub. No.: US 2008/0127118 A1
(43) Pub. Date: May 29, 2008

(54) Method and system for dynamic patching of software

(76) Inventor: Bulent Kasman, Antioch, CA (US)

Correspondence Address: FAY KAPLUN & MARCIN, LLP, 150 BROADWAY, SUITE 702, NEW YORK, NY, 10038, US

(21) Appl. No.: 11/541,893

(22) Filed: Oct. 2, 2006

(51) Int. Cl. G06F 9/44

(52) U.S. Cl. 717/130

(57) ABSTRACT

A method for determining an instrumentation location within a running user code, inserting a branch instruction at the instrumentation location, the branch instruction being used execute a separately compiled instrumentation code from the running user code, determining whether there is at least one task of the user code being executed, and executing the branch instruction when it is determined that no task of the user code is being executed. A system having a browsing module determining an instrumentation location within a running user code, an insertion module inserting a branch instruction at the instrumentation location, the branch instruction being used execute a separately compiled instrumentation code from the running user code, a determination module determining whether there is at least one task of the user code being executed, and an execution module executing the branch instruction when it is determined that no task of the user code is being executed.

### INCORPORATION BY REFERENCE

The following application hereby incorporates by reference each of the following applications filed on an even date herewith, including the application titled “Method and System for Parameter Profile Compiling” by inventor Bulent Kasman in its entirety, the application titled “Method and System for Editing Code” by inventors Bulent Kasman and Edmund dela Cruz in its entirety, and the application titled “Method and System for Dynamic Debugging of Software” by inventor Bulent Kasman in its entirety.

### BACKGROUND

The ability to build, debug, and deploy software programs onto a target device is critical to software development. Debugging often involves monitoring variables, parameters, and/or resources used in a software program. One conventional method of monitoring involves inserting print statements within the program's code and performing a diagnostics session. Monitoring may also be performed during specific times of the program's execution. For example, breakpoints are often used to pause or terminate program execution, allowing the developer perform a diagnostics session in order to view the status of the variables, parameters, and resources at the specified times. However, the conventional debugging methods described above are limited. Since changes to the program code are required during debugging, the program must be recompiled and re-executed in order to view the results of these changes. Thus, the conventional debugging methods cannot be applied to programs that are currently being executed without interrupting the operation of the programs.

Additional diagnostics interactions with the program code on the target device may also be required, such as downloading patches, extracting data related to program performance and servicing, and/or collecting parameter data relating to a business operating the program. The performance of these interactions may require diagnostics data storage on the target device, thereby limiting the resource of the target device and increasing the overhead required to effectively operate the program code once deployed onto the target device.

### SUMMARY OF THE INVENTION

The present invention relates to a method and system for dynamic patching of software. According to an embodiment of the present invention, the method comprises determining an instrumentation location within a running user code, inserting a branch instruction at the instrumentation location, the branch instruction being used execute a separately compiled instrumentation code from the running user code, determining whether there is at least one task of the user code being executed, and executing the branch instruction when it is determined that no task of the user code is being executed. According to another embodiment of the present invention, the system comprises a browsing module determining an instrumentation location within a running user code, an insertion module inserting a branch instruction at the instrumentation location, the branch instruction being used execute a separately compiled instrumentation code from the running user code, a determination module determining whether there is at least one task of the user code being executed, and an execution module executing the branch instruction when it is determined that no task of the user code is being executed. In a further embodiment of the present invention, the system comprises a memory storing user code and a separately compiled instrumentation code, and a processor configured to execute the user code and the separately compiled instrumentation code, wherein the execution of separately compiled instrumentation code occurs during execution of the user code provided that no task of the user code is being executed.

### BRIEF DESCRIPTION OF THE DRAWINGS

FIG. 1 shows an exemplary system for generating a parameter profile for capturing information to interpret a diagnostic log according to embodiments of the present invention.

FIG. 2 shows an exemplary embodiment of a system for networked software development according to exemplary embodiments of the present invention.

FIG. 3 shows an exemplary method for software development according to embodiments of the present invention.

FIG. 4 shows an exemplary illustration of the insertion of sensorpoint code into a specific instrumentation point location within the user code of a running application according to embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods used to develop, test and debug software. Specifically, the present invention is related to systems and methods for dynamically inserting software into a running software (application, kernel, driver, etc) in an embedded device by means of patching a branch instruction (i.e., “dynamic patching”) at a specific address. Dynamic patching may allow software developers and engineers to debug any errors within an application on a device in a field environment without shutting down or rebooting the device with instrumented software. This process may be extremely useful when shutting down or rebooting the device is undesirable or even impossible. Without impacting the operating of the device, dynamic patching of instrumentation code to precise locations within the source code may provide the most accurate information for diagnosing device performance and/or identifying any possible errors. Thus, the present invention may eliminate the requirement for recreating an equivalent error within a development environment, thereby drastically reducing the time needed for defect resolution.

Software applications are often created on a host computing device and ported to a target device. This type of development is typical for embedded devices. An embedded device is any device that includes a processor or microcontroller that executes software to carry out desired functions. Normally, an embedded device has fewer resources than a general purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc. The exemplary embodiments of the present invention will be described with reference to a diagnostic tool for such embedded devices. However, those skilled in the art will understand that the present invention may be implemented in, for example, a diagnostic tool for software executing on any type of device. As will be described in greater detail below, additional independent program code may be installed onto the target device in order to collect useful diagnostic information during the development of the software application. Embodiments of the present invention will be described with reference to the development of software applications for these target devices in both networked and non-networked environments.

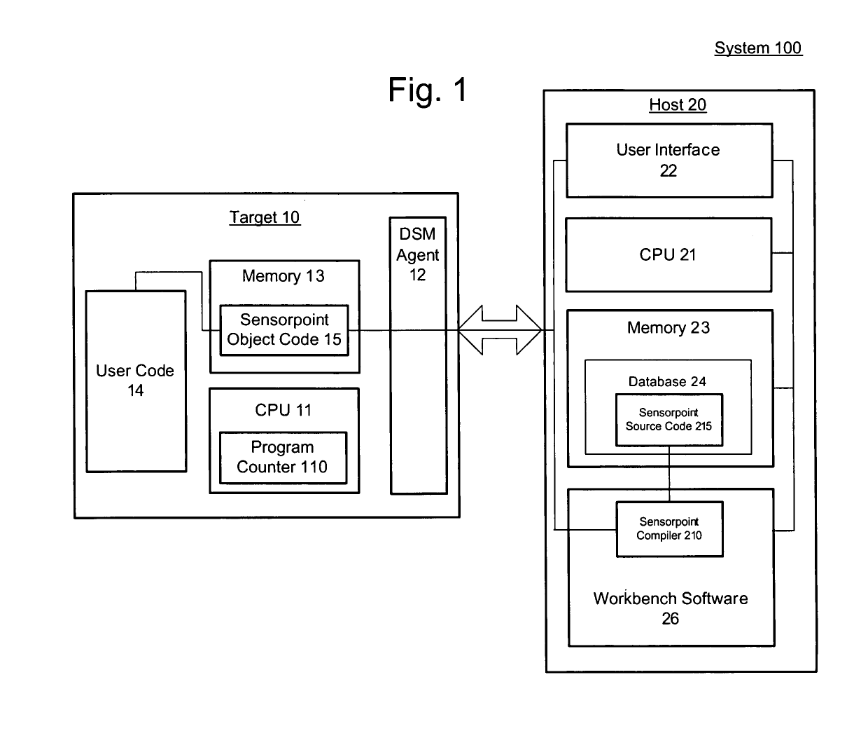

FIG. 1 shows an exemplary system 100 for integrating the editing, compiling and installing of program code within an application according to exemplary embodiments of the present invention. The system 100 includes a target device 10 and a host device 20. In one embodiment, both the target 10 and the host 20 may be located in a lab environment, while in another embodiment, the target 10 and/or the host 20 may be in a field environment. For example, the target 10 may be deployed in a warehouse, office, etc., while the host resides in a laboratory or central server location. The host 20 may include conventional computing components such as a central processing unit (“CPU”) 21 (e.g., a microprocessor, an embedded controller, etc.) and a memory 23 (e.g., Random Access Memory, Read-only Memory, a hard disk, etc.). Likewise, the target 10 may also include a CPU 11 and a memory 13. Communication between the target 10 and the host 20 occurs over a communication link, which may be a wired (e.g., Ethernet, serial port, Universal Serial Bus, etc.) or wireless (e.g., Bluetooth, IEEE 802.1x , etc.) connection.

The host 20 may further include a user interface 22, a database 24, and workbench software 26. The user interface 22 enables a developer (e.g., a user) to interact with the host 20 by receiving instructions and data requests. Throughout the description, the term developer will be used to refer to a user of the system and method disclosed herein, wherein a user may be a software engineer, a test engineer, a quality assurance engineer, support personnel, etc.

The user interface 22 may comprise any number of standard input and/or output devices, such as a keyboard, a mouse, a display, etc. Through the user interface 22, the developer may instruct the host 20 to transmit data to and/or from the target 10. The data may include sensorpoint modules and monitoring data. As will be discussed in detail below, sensorpoint modules comprise program code that the developer can implement on the target 10. Monitoring data may include any relevant data that the developer wishes to receive from the target 10, such as device information, alarms and error messages, log information, and audit information (e.g., information related to users modifying devices and/or sensorpoint modules). The monitoring data may also relate to device type. For example, if the target 10 is a cell phone, the monitoring data may include call usage information, signal strength information, etc. The monitoring data may be transmitted automatically (e.g., at predetermined intervals) or upon request by the developer. For example, the user may request to view a log file generated by the target 10 in order to view specific program output.

The workbench software 26 is a software development tool used by the developer to create, modify, and debug software programs. The workbench software 26 may comprise a software suite that includes any number of individual software development programs, such as a compiler, a debugger, a source code analyzer, a text editor, etc. These individual programs may either be run independently of a running application or within a main development program. Using the workbench software 26, the user can create a sensorpoint module, write and edit code for the sensorpoint module, compile the code, abstract a parameter profile from the compiled code, and save the sensorpoint module to the database 24 or as a local file system. Once the sensorpoint module is saved, it may be selected for transmission to the target 10. Those skilled in the art will understand that the sensorpoint code as written may not be the same as the actual code executed by the target 10. For example, the actual code may be an executable binary file created as a result of compiling and linking the sensorpoint code. The binary may be included in the sensorpoint module as an object file. In addition, the sensorpoint module may include multiple files, such as source, header and library files. These files may be installed individually or together with the entire sensorpoint module.

The database 24, or the local file system, stores sensorpoint modules, monitoring data (e.g., diagnostics logging data), and other types of data specified by the developer. The database 24 may also include user information, customer information, information regarding the target 10 (e.g., device type), parameter information regarding a business process, etc. The database 24 may be organized in any number of ways, including separate data structures for holding information corresponding to a specific target, a specific data type (e.g., sensorpoint modules), etc. The database 24 also allows for sensorpoint modules to be grouped together according to the specifications of the developer. For example, the developer may wish to group sub-components of a larger program together. The database 24 is located on writable memory 23, and may be accessed via the user interface 22.

The target 10 may include a Device Software Management (DSM) agent 12 that communicates with the host 20 via the communication link. The DSM agent 12 coordinates the sending and receiving of data. Instructions and data requests are received by the DSM agent 12 and processed accordingly. When data is transmitted or received, the DSM agent 12 may first place the data into a buffer. For example, received sensorpoint modules may be temporarily stored in a buffer before writing to the memory 13 of the target 10. Likewise, data transmitted to the host 20 may first be placed in a buffer and sent when the data is ready for transmission and/or the host 20 is ready to receive the data. The DSM agent 12 may be implemented in hardware, software, or a combination thereof.

The target 10 operates using a user code 14, which comprises a program running in an operating system or a stand-alone program. The user code 14 may be written in any programming language (e.g., C/C++, Java, Assembly language, etc.). The user code 14 may be any program that the developer wishes to run on the target 10. For example, the user code 14 may be a main program or subroutine being developed for implementation on the target 10. The user code 14 may include source, header, library, object, and other data files.

The target 10 may also include sensorpoint object code 15. Similar to the user code 14, the sensorpoint object code 15 may include source, header, library and object files. According to the embodiments of the present invention described herein, a sensor point is defined as a piece of code that is compiled independently of a running application (e.g., the compiled user code 14). The sensorpoint object code 15 may be executed by the running application via branch instructions inserted into the running application (e.g., the executable binary). The sensorpoint object code 15 may include keywords for logging purposes, wherein the keywords may correspond to both sensorpoint directives (e.g., sensorpoint thread) and instrumentation points identifying the locations of the user code 14. The use of the keywords for the generation of parameter profiles will be described in detail below.

The target 10 may also include a program counter 110. The program counter 110 may be defined as a component of the CPU 11 that indicates which instruction in an instruction sequence is currently being executed and may contain the address of the next instruction that is to be executed. In other words, the program counter 110 may indicate a location, or address, in the memory 13 for currently executing instructions and the next instructions to be executed. The program counter 110 may be automatically incremented for each cycle of the instruction sequence so that instructions are retrieved in proper sequential order from the memory 13. However there may be certain instructions, such as a branch (or jump) instruction, that interrupt the sequence by placing a new value in the program counter 110. The functionality of the program counter 110 will be described in further detail below.

Those skilled in the art will understand that the system 100 and the various components described for the host 20 and the target 10 are only exemplary and are being used to illustrate an exemplary embodiment for dynamically patching a branch instruction into software on the target 10 according to the present invention. However, dynamic patching of the present invention may be implemented on systems that do not include the components described herein, e.g., sensorpoints. Those skilled in the art will understand that the functionality described herein for dynamic patching may be implemented on other systems that do not include sensorpoints. That is, the dynamic patching described herein may be used to insert any separately compiled code into running user code (or other running code). Thus, the term “instrumentation code” will be used to describe any type of separately compiled code that a developer (or other person) may desire to insert into currently running code.

Those skilled in the art will understand that the system 100 and the various components described for the host 20 and the target 10 are only exemplary and are being used to illustrate an exemplary embodiment for dynamic patching of software code into a running device according to the present invention. However, the dynamic patching of the present invention may be performed on systems that do not include the components described herein, e.g., sensorpoints. Those skilled in the art will understand that the functionality described for dynamic patching may be performed on any executable code. Such executable code may have the same characteristics as a sensorpoint (e.g., compiled code that is executed without interrupting the execution of the user code 14) or it may have different characteristics. Thus, the functionality of concern is the ability to dynamically patch software code into a running target 10, without shutting down or rebooting the target 10 with instrumented software.

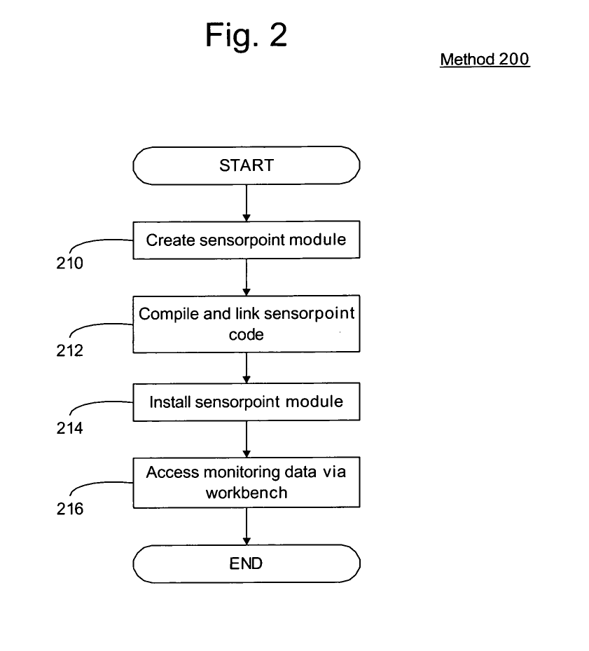

FIG. 2 shows an exemplary method 200 for software development according to the present invention that will be discussed with reference to the system 100. Beginning with step 210, a sensorpoint module is created using the workbench software 26. As previously discussed, the sensorpoint module is a software component that includes the compiled sensorpoint source code 215 and instructions relating to how the compiled sensorpoint source code 215 should be implemented. An exemplary sensorpoint source code 215 may be written in the C programming language, compiled and linked on the host 20, saved as a sensorpoint module in the database 24, and transmitted to the target 10 for execution. As will be described in greater detail below, branch instructions are inserted into a specific location(s) (i.e., the instrumentation points) of the user code 14 as desired by the developer, and may also be transmitted from the host 20 as part of the sensorpoint module. In other embodiments, the sensorpoint source code 215 may be written and the instrumentation points specified through a user interface located on the target 10 itself. The branch instructions may be inserted by patching the running user code 14 with precompiled branch instructions pointing to the sensorpoint object code 15. When the application reaches the instrumentation point(s), the sensorpoint object code 15 is run before execution of the user code 14 resumes. Thus, the developer may debug and develop the user code 14 without having to reboot, recompile, or interrupt the execution of the user program.

The workbench software 26 may be accessed using the user interface 22, or from the target 10 if the target 10 has its own user interface. If the sensorpoint module is a newly created module, the sensorpoint code is written, which includes specifying user code 14 locations in which branch instructions should be placed. The Sensorpoint code is then compiled and stored in the database 24 (or a file system). Alternatively, if the sensorpoint module already exists, the existing sensorpoint code is modified and saved.

In step 212, the sensorpoint code is compiled using the workbench software 26 and saved in the database 24 along with the rest of the sensorpoint module. The sensorpoint code is then linked. That is, the individual files (source, header, library, etc.) that comprise the sensorpoint code are combined into a single executable file (i.e., the executable binary). For example, if the programming language is C, the individual files may be placed into a User Sensorpoint Module (USM) file.

In step 214, the compiled sensorpoint source code 215 is installed by transmitting the compiled sensorpoint source code 215 as sensorpoint object code 15 from the host 20 to the target 10. The DSM agent 12 receives the sensorpoint object code 15, saves it into memory allocated to the sensorpoint object code 15, processes the executable binary and updates the user code 14 with the branch instructions. During this time, the target 10 continues to execute the user code 14 and does not encounter any interruption during running of the user code 14. If the user code 14 encounters the instrumentation point(s) during execution, program execution sequence is interrupted, and routed through sensorpoint code.

In step 216, the monitoring data is accessed via the workbench software 26. The developer views the monitoring data, determines whether results of the user program are as expected and, if necessary, makes changes to the sensorpoint object code 15 by repeating steps 210-216.

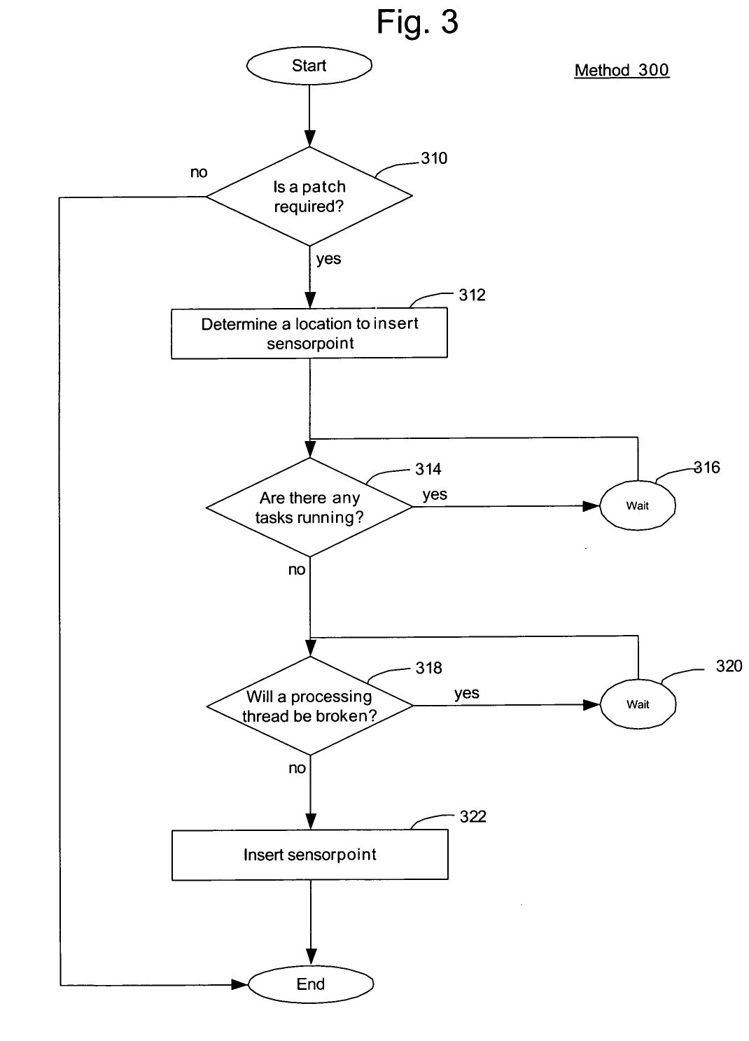

FIG. 3 shows an exemplary method 300 for dynamically inserting a sensorpoint object code 15 into a running application without crashing the running application. The exemplary method 300 will be also described with reference to the exemplary system 100 of FIG. 1 and may provide greater detail for step 214 of exemplary method 200 of FIG. 2. According to the present invention, the method 300 may provide a solution for patching a branch instruction for inserting sensorpoint object code 15 into a precise point of the user code 14 running on a target 10 without impacting the performance of the target 10. Crashing an application may be described as causing a software application or a computer operating system to stop performing an expected function and, thereby, failing to operate or respond to other components of system. A crash may be caused by the execution of single machine instruction resulting from erroneous instruction sequencing from the program counter 110 (or instruction pointer) of the CPU 11. As described above, the program counter 110 may be a component that indicates which instruction in an instruction sequence is currently being executed on the target 10 and may contain the memory address of the next instruction that is to be executed. Certain instructions, such as a branch instruction may interrupt the instruction sequence by placing a new value in the program counter 110. The branch instruction may be described as a break in the instruction sequence of computer processing, wherein the address of the branch instruction is not in the next sequential storage location in memory 13. The exemplary method 300 according to the present invention may for dynamic insertion (or “patching”) of a sensorpoint into an instruction sequence without affecting the operation of the running program.

In step 310, a determination may be made as to whether a branch instruction is needed within user code 14 on the deployed target 10. One skilled in the art would understand that there may be several instances where a branch instruction may be required. These instances include, but are not limited to, updating the user code 14 to a newer version, improving the usability or performance of a program, inspecting the capabilities of a program, and/or general debugging of software bugs (e.g., errors, defects, etc.) in program design or source code. Thus exemplary embodiments of the present may allow for post-development device management, thereby providing an opportunity for remotely monitoring, diagnosing, and repairing the deployed target 10.

In step 312, the method 300 may determine a specific instrumentation location for inserting the sensorpoint object code 15. The determination of the location may be accomplished through browsing the user code 14 of the target 10. Those skilled in the art would understand that the location may also be determined by the program counter 110 of a CPU 11. As described above, the program counter 110 may store a number, or memory address, that may identify the current position in the program memory 13, thereby allowing the CPU 11 to keep track of the its place in the program. Similar to a branch instruction, the instrumentation location for the sensorpoint object code 15 may interrupt the processing sequence of the CPU 11 by placing a new value within the program counter 110. Thus, step 312 may place the address of the instrumentation location within the sequence of the user code 14, thereby allowing for the instruction within the sensorpoint object code 15 to be executed as the next set of instructions. Once the instructions within the sensorpoint object code 15 are executed, the program counter 110 may return to the sequential address of the user code 14.

In step 314, a determination may be made as to whether there are any currently running tasks (or processes). The program counter 110 may make this determination. Those skilled in the art would understand that a task may be defined as a unit of computation that provides an execution path through the address locations. A task may be computationally independent, wherein the task does not modify data that is referenced within a separate task. Thus, if multiple computationally independent tasks are running in parallel (i.e., the same time), then the results of executions will not interfere with the performance of the other tasks. Alternatively, certain tasks may have dependencies on other tasks. An exemplary dependent task may run until it requires a specific result from another task. Upon requesting this result, the dependent task may continue to wait for the required result prior to terminating or resuming instructions. Optionally, the CPU 11 may be given a time interval for performing the task. If the time interval has expired, the CPU 11 may terminate the task and initiate a new task in order to prevent any task from monopolizing the processing resources of the CPU 11. Thus, in step 314, the program counter 110 may examine the instruction set to determine which, if any, tasks are currently running. The program counter 110 may also determine if any dependent tasks are awaiting results from another tasks. If it is determined that tasks are either running or awaiting results, then the exemplary method 300 may proceed to step 316. In 316, the method 300 may wait until there are no running tasks. If it is determined that no tasks are running, then the method 300 may the advance to step 318.

In step 318, a determination may be made as to whether any processing threads may be broken. A thread, or thread of execution, may be defined as a stream of computer instructions for controlling a process of a software program. Threads may allow for the program to be split into two or more near-simultaneously running tasks. Furthermore, those skilled in the art would understand that each of these tasks may include a task object that represents and controls a specific task. The task object may be an instance of the class that represents a current thread of execution. Therefore, during step 318 the task objects of the target's source code may be examined in order to determine whether dynamically inserting the sensorpoint object code 15 would break any processing threads. Depending on the instruction set architecture (“ISA”) of the target CPU 11, the exemplary method 300 may take into consideration that the target CPU 11 is between instructions. For example, more complex processors, such as for example, an x86 processor, may allow for variable length instructions and support various complex addressing modes. If it is determined that a processing thread would be broken, then the exemplary method 300 may proceed to step 320. In 320, the method 300 may wait until the processing thread is complete. If it is determined that processing thread is complete, then the method 300 may the advance to step 318.

Optionally, during step 318 of the exemplary method 300, the program counter 110 may also provide a listing of all currently running tasks within the CPU 11. A determination may be made as to whether, upon completion, one of the currently running tasks will return an address that is used for the patched sensorpoint object code 15. If a task is returning to that address, the sensorpoint object code 15 may not be dynamically patched into the target user code 14 at that time. This may prevent the sensorpoint object code 15 from corrupting the processing of the returning task.

A further option at step 318 of the exemplary method 300, if the current address cannot be replaced with a branch instruction to the sensorpoint object code 15, an interrupt (trap) instruction may be used as instrumentation branch. The trap instruction may be shorter than the branch instruction and may be used when the branch instruction is not possible. For example, if the particular CPU architecture requires a branch instruction to have longer instruction length than some other instructions, replacing multiple instructions may be necessary to insert a branch instruction for the instrumentation. However, if there is a jump instruction inside the user code to the address of one of the instructions (not the first one) that will be replaced, then inserting a branch to that address may be unsafe.

In step 322, the sensorpoint object code 15 may be inserted into the precise instrumentation location through patching a branch instruction in the user code 14. Having dynamically inserted the sensorpoint object code 15 onto the target 10 without impacting the operation of the target 10, it is possible to gather diagnostic information from the target 10, itself. Once the sensorpoint object code 15 has been executed, the target user code 14 may resume. Therefore exemplary method 300 may allow software developers to perform diagnostic tests on a deployed target device without the need to reproduce a potential software bug in a laboratory setting. As opposed to rebuilding a software representation of the target 10 with the patched sensorpoint object code 15 to receive diagnostic information of the software representation, the exemplary method 300 provides the most accurate diagnostic information related to the nature of a potential problem from the target itself. In other words, the exemplary method 300 may shorten defect resolution of the deployed device and allows for rapid isolation of problems and the causes of the problems. It is important to note that while the exemplary method 300 illustrates the present invention implemented on a single deployed device, embodiments of the present invention may be deployed on multiple device, such as, for example, devices of a same group or model type.

It should be noted that sensorpoint object code 15 may be dynamically disabled by following the same process, and replacing the previously inserted branch instruction with the original instruction of the user code. This operation may also safe and may not impact running target user code 14.

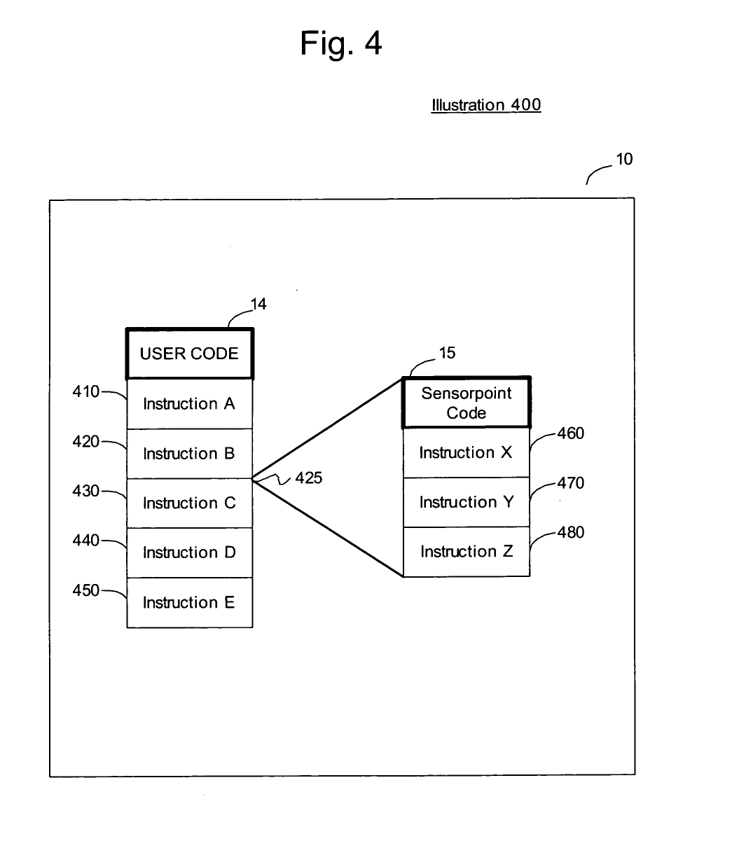

FIG. 4 shows an exemplary illustration 400 of the insertion of sensorpoint object code 15 into a specific instrumentation point location 425 within the user code 14 of a running application. The exemplary illustration 400 will be also described with reference to the exemplary system 100 of FIG. 1. The target 10 may include both the user code 14 and the sensorpoint object code 15. According to this exemplary illustration 400, the user code 14 may contain lines of instructions, such as, for example, Instruction A 410, Instruction B 420, Instruction C 430, Instruction D 440, and Instruction E 450. Furthermore, the sensorpoint object code 15 may contain additional lines of instructions, such as, for example, Instruction X 460, Instruction Y 470, and Instruction Z 480.

According to the exemplary illustration 400, the sensorpoint object code 15 may be compiled and linked independently at an external location, such as at the host 20 (not shown), and subsequently transmitted to target 10. The execution of the sensorpoint object code 15 may be accomplished in the user code 14 of the target via branch instructions inserted at an instrumentation point 425. For example, the desired location for the instrumentation point 425 of the sensorpoint object code 15 may be determined to be between Instruction C 430 and Instruction D 440 of the user code 14. The software developer may make the determination of the desired location of the instrumentation point 425. It is important to note that prior to inserting the sensorpoint object code 15, there are no tasks that are currently running on target 10 and there are no processing threads that would be broken during the insertion of the sensorpoint object code 15.

As described above, the instructions of the sensorpoint object code 15, Instruction X 460, Instruction Y 470, and Instruction Z 480, may be inserted by patching the user code 14 with precompiled instructions pointing to the instrumentation point 425. When the user code 14 reaches the instrumentation point 425, the sensorpoint object code 15, namely, Instruction X 460, Instruction Y 470, and Instruction Z 480, may run before the execution of Instruction C 430 of the user code 14. Upon completion of the sensorpoint object code 15, the user code 14 may resume. Those skilled in the art would understand that the location of instrumentation point 425 within user code 14 may vary, and furthermore, there may be more than one instrumentation point for the insertion of one of more sensorpoints. Thus, the exemplary embodiments of the present invention may allow the developer to develop and debug the user code 14 without interrupting the execution of the user code 14.

It is important to note that test engineers may also use the sensorpoint object code 15 to alter the execution paths of user codes 14. The altering of execution paths may allow the engineers to test specific portions of the user code 14 that otherwise may require a complex setup. For example, a sensorpoint instruction inserted inside malloc( ) instruction of a system may cause a function to return “0” despite the fact that there may be sufficient memory in the system. Advantageously, engineers may benefit from the versatile features available to sensorpoints, thereby allowing for a reduction from an edit-compile-deploy-test cycle to simply an edit-test cycle. Furthermore, the present invention may allow for the seamless integration of editing compiling and installing of sensorpoints functionalities such that the developer may avoid entering the same information in multiple locations and avoid switching between applications during the task of installing one or more sensorpoints.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
determining an instrumentation location within a running user code;
inserting a branch instruction at the instrumentation location, the branch instruction being used execute a separately compiled instrumentation code from the running user code;
determining whether there is at least one task of the user code being executed; and
executing the branch instruction when it is determined that no task of the user code is being executed.

2. The method of claim 1, further comprising:
waiting for the at least one task to terminate prior to executing the branch instruction.

3. The method of claim 1, further comprising:
executing the separately compiled instrumentation code.

4. The method of claim 3, further comprising:
returning to execute the user code after the separately compiled instrumentation code is executed.

5. The method of claim 1, wherein the separately compiled instrumentation code is a sensorpoint.

6. The method of claim 1, wherein the determining whether at least one task is being executed includes:
determining whether a task object is active.

7. The method of claim 1, further comprising:
providing a listing of currently executing tasks.

8. The method of claim 7, further comprising:
determining whether, upon completion, one of the currently executing task will return to an address that is used for the separately compiled instrumentation code; and
canceling the execution of the branch instruction when the one of the currently executing tasks is determined to return the address that is used for the separately compiled instrumentation code.

9. A system, comprising:
a browsing module determining an instrumentation location within a running user code;
an insertion module inserting a branch instruction at the instrumentation location, the branch instruction being used execute a separately compiled instrumentation code from the running user code;
a determination module determining whether there is at least one task of the user code being executed; and
an execution module executing the branch instruction when it is determined that no task of the user code is being executed.

10. The system of claim 9, wherein the execution module waits for the at least one task to terminate prior to executing the branch instruction.

11. The system of claim 9, wherein the execution module executes the separately compiled instrumentation code.

12. The system of claim 11, wherein the execution module returns to execute the user code after the separately compiled instrumentation code is executed.

13. The system of claim 9, wherein the separately compiled instrumentation code is a sensorpoint.

14. The system of claim 9, wherein the determination module determines whether a task object is active.

15. The system of claim 9, further comprising:
a listing module providing a listing of currently executing tasks.

16. The system of claim 15, wherein the determination module determines whether, upon completion, one of the currently executing task will return to an address that is used for the separately compiled instrumentation code and cancels the execution of the branch instruction when the one of the currently executing tasks is determined to return the address that is used for the separately compiled instrumentation code.

17. A system, comprising:
a memory storing user code and a separately compiled instrumentation code; and
a processor configured to execute the user code and the separately compiled instrumentation code, wherein the execution of separately compiled instrumentation code occurs during execution of the user code provided that no task of the user code is being executed.

18. The system of claim 17, wherein the separately compiled instrumentation code is executed by inserting a branch instruction into the user code.

19. The system of claim 17, wherein, when a task of the user code is being executed, the processor waits until completion of the task prior to executing the separately compiled instrumentation code.

20. The system of claim 17, wherein the separately compiled instrumentation code is a sensorpoint.
